(19) United States
(12) Patent Application Publication
(10) Pub. No.: US 2011/0007023 A1
(43) Pub. Date: Jan. 13, 2011

(54) DISPLAY DEVICE, TOUCH SCREEN DEVICE COMPRISING THE DISPLAY DEVICE, MOBILE DEVICE AND METHOD FOR SENSING A FORCE ON A DISPLAY DEVICE

(75) Inventors: Magnus Abrahamsson, Loddekopinge (SE); Gunnar Klinghult, Lund (SE); Martin Ek, Dalby (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/537,163

(22) Filed: Aug. 6, 2009

Related U.S. Application Data
(60) Provisional application No. 61/224,141, filed on Jul. 9, 2009.

(51) Int. Cl. G06F 3/045

(52) U.S. Cl. 345/174

(57) ABSTRACT

The present invention relates to a display device, touch screen device comprising a display device, mobile device and method for sensing a force on a display device. The display device provides a user interface for controlling different functions allowing additional and more flexible input operations. The display device comprises a first layer made at least partly of a transparent material, a second layer arranged at one side of the first layer, the first and second layers forming faces of a cavity including a fluid, and pressure sensing device for sensing a pressure in said fluid.

### FIELD OF THE INVENTION

The present invention relates to a display device, touch screen device comprising a display device, mobile device and method for sensing a force on a display device. In particular, the display device may serve as a user interface for controlling different functions in a device incorporating the display device.

### BACKGROUND

Different kinds of sensors serving as user interfaces in a device, such as a mobile device, in particular a mobile phone, are known in the art for sensing an input action of a user. When using a touch sensor, the input is performed by touching the sensor surface with a finger or stylus. Hence, touch sensors may provide a user interface or man-machine interface to control various functions of the device having the touch sensor incorporated therein.

Known touch sensors, e.g. available from Cypress Semiconductor, which are often combined with liquid crystal displays (LCDs) to form a touch screen, work by reacting to a change in resistance or capacitance affected by the presence of a finger or a stylus of a user on top of this sensor. Since touch sensors are usually placed on top of the LCD, large parts of the sensor have to be made transparent, which can be achieved by manufacturing the touch sensor from Indium Tin Oxide (ITO).

The position sensing capability is achieved for example, by providing two layers with capacitive components in the touch sensor. These components are connected with each other horizontally in the first layer and vertically in the second layer to provide a matrix structure enabling to sense a position in x,y-coordinates of where the sensor is touched. In capacitive touch panels, the capacitive components of one layer forms one electrode of a capacitor and the finger or stylus on top of the touch sensor forms another electrode.

For instance, the so-called CapTouch Programmable Controller for Single Electrode Capacitance Sensors AD7147 manufactured by Analog Devices, Norwood, Mass., U.S.A. (see Data Sheet, CapTouch™ Programmable Controller for Single Electrode Capacitance Sensors, AD7147, Preliminary Technical Data, 06/07—Preliminary version F, 2007 published Analog Devices, Inc) may be used to measure capacitance.

Recent applications, such as multi-touch applications, require that more than one position on a touch sensor is touched and sensed, e.g. to determine a section of an image on a display that is to be magnified. As applications become more complex, new improved user interfaces are needed.

Therefore, it is desirable to provide a display device, touch screen device, mobile device and method allowing additional and more flexible input operations.

### DISCLOSURE OF THE INVENTION

A novel display device, touch screen device, mobile device and method for sensing a force on a display device are herein presented and defined in the appended independent claims. Advantageous embodiments are defined in the dependent claims.

An embodiment of the invention provides a display device comprising a first layer made at least partly of a transparent material and a second layer arranged at one side of the first layer. The first layer and the second layer form faces of a cavity which includes a fluid. Further, the display device comprises a pressure sensing device for sensing a pressure in the fluid.

Accordingly, if the pressure in the fluid increases due to a force applied somewhere on the outside of the cavity, this pressure change may be detected by the pressure sensing device so as to correlate an externally applied force with sensed pressure. Hence, a force sensitive display device is provided, wherein depending on the force an input operation, such as triggering a function of a mobile device, may be defined.

In one embodiment, the pressure sensing device and the cavity are adapted and coupled so that a force applied to the first layer of the cavity is communicable by the fluid to the pressure sensing device. Accordingly, the presence of a force applied to the first layer of the cavity can be detected and its magnitude may be determined based on the sensed pressure.

In one embodiment, the pressure sensing device is arranged inside the cavity or on the circumference of the cavity. Accordingly, small pressure variations in the cavity can be directly sensed.

In one embodiment, the pressure sensing device is placed outside the cavity and the cavity is coupled with the pressure sensing device by a channel adapted to carry the fluid. Accordingly, there is high flexibility in arranging and mounting the pressure sensing device.

In one embodiment, the pressure sensing device comprises a piezoresistive element. Accordingly, the pressure sensing device can be made small, reliable and of low cost.

In one embodiment, the fluid is a birefringent fluid, such a fluid of liquid crystals used in a liquid crystal display (LCD). Accordingly, known LCDs can be easily adapted to be used as a pressure indicator and thus as an indicator for indicating a force applied to an LCD.

In one embodiment, the display device further comprises at least two electrodes arranged between the first and second layers so as to change the polarization property of the birefringent liquid. Accordingly, the orientation of liquid crystal molecules can be changed so as to modulate the phase of light passing through the cavity.

In one embodiment, the display device comprises two polarisers with a polarization direction being perpendicular to each other. Accordingly, dependent on the orientation of liquid crystal molecules of the birefringent liquid, light may pass the two polarisers or may be blocked.

In one embodiment, the display device comprises a determination section for determining a signal level based on a sensed pressure. In a specific embodiment, the determination section determines at least one of the force applied through a user input and the air pressure. Accordingly, by determining the signal level, a force or pressure acting on the first or second layer or the cavity is obtained. Therefore, calibration may be performed to indicate or at least estimate the magnitude of an applied force or pressure. For example, the speed of a scrolling operation on a display of the display device may be controlled so that the speed of scrolling is increased by increasing the force on the area touched.

According to another embodiment, a touch screen device is provided comprising one of the above-described display devices. Specifically, the second layer of the display device may be made at least partly of a transparent material, i.e. light-transmissive. Further, a light source, such as a white light source, may be provided on a side of the second layer, other than the side facing the fluid. Accordingly, a touch screen device having a display device of an active transmissive type is provided, allowing to view the display also at low ambient light levels or at night.

In one embodiment, the touch screen device comprises a touch sensor arranged on a side of the first layer other than the side facing the fluid to sense a position touched on a touch area defined by the touch sensor. Accordingly, in addition to a force-sensitive input operation, e.g. in the z-direction, i.e. substantially perpendicular to the first layer, other input operations in an x,y-plane, such as to obtain x,y-coordinates of a location, can be obtained.

According to another embodiment, a mobile device is provided comprising one of the above-described display devices or one of the above-described touch screen devices. Accordingly, a mobile device may be provided with a novel type of user interface, wherein an input operation is dependent on a force or certain magnitude of a force applied to the cavity.

Another embodiment of the invention provides a method for sensing a force on a display device having a first layer and a second layer forming faces of a cavity including a fluid. The method comprises the steps of applying a force to the first layer, sensing a pressure in a fluid based on the force applied to the first layer and communicated by the fluid, and determining a signal level based on the sensed pressure. Accordingly, an input operation may be provided, which depends on the force applied to the cavity or even a change in outside ambient pressure acting on the cavity may be detected.

### BRIEF DESCRIPTION OF THE DRAWINGS

Embodiments of the invention will be described with respect to the following appended figures.

FIG. 1A illustrates a display device and elements thereof according to an embodiment of the invention.

FIG. 1B illustrates a display device and elements thereof when a force is applied according to another embodiment of the invention.

FIG. 2 illustrates a display device and elements thereof according to another embodiment of the invention.

FIG. 3 illustrates a display device according to a specific embodiment of the invention.

FIG. 4 illustrates a flow diagram of a method for sensing a force or pressure on a display device according to an embodiment of the invention.

FIG. 5 illustrates a touch screen device and its elements including a display device according to a specific embodiment of the invention.

### DESCRIPTION OF THE EMBODIMENTS

The further embodiments of the invention are described with reference to the figures and should serve to provide the skilled person with a better understanding of the invention. It is noted that the following description contains examples only and should not be construed as limiting the invention.

In the following, similar or same reference signs indicate similar or same elements.

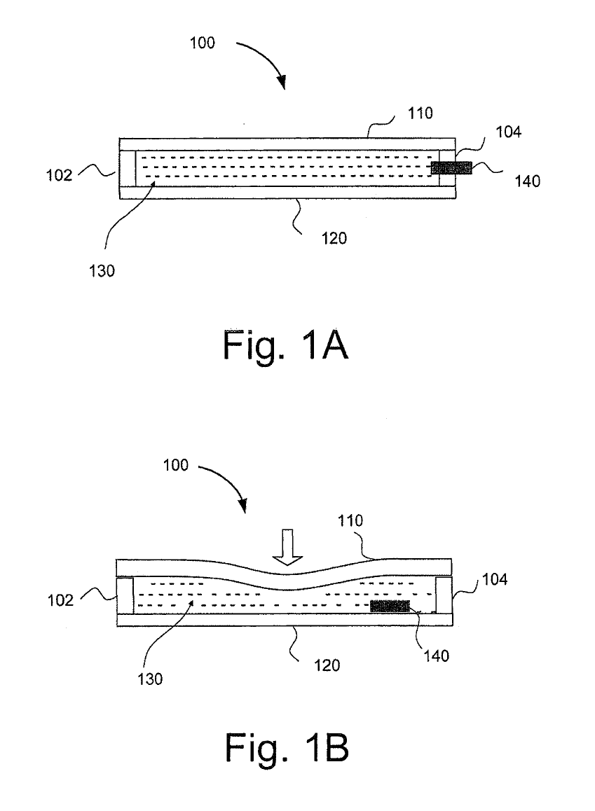

FIGS. 1A and 1B illustrate elements of a display device 100 according to two embodiments of the invention. FIG. 1A illustrates a display device 100 comprising a first layer 110, a second layer 120 and a pressure sensing device 140. As shown in FIG. 1A, the second layer 120 is arranged at one side, here the bottom side, of the first layer 110, wherein the two layers form faces of a cavity 130. The cavity 130 contains a fluid indicated with dashes. The first layer 110 is made at least partly of a transparent material so that light from the outside is incident in the cavity 130 passing the first layer or vice versa, i.e. light from the cavity passes through the first layer to the outside.

The pressure sensing device 140 senses a pressure in the fluid. In particular, a pressure change in the fluid may be sensed, if the shape or volume of the cavity changes, e.g. due to a force or pressure from the outside. For example, an external force may be applied from the outside by a user of the display device pressing against the first layer, which is indicated by the arrow in FIG. 1B. Depending on the area, on which the force is applied, a pressure may be determined so that pressure and force are proportional and will be used interchangeably in the following.

As shown in FIG. 1B, the pressure sensing device 140 and the cavity 130 are adapted and coupled so that a force applied to the first layer 110 of the cavity 130 is communicable through the fluid to the pressure sensing device 140 sensing an increase in pressure once a force is applied. It is clear that in the case of totally stiff first and second layers and cavity, the pressure in the fluid in the cavity would not change once a force is applied to the cavity and thus a pressure sensing device cannot be used to detect the force.

Therefore, in one example, the first layer is made of a somewhat flexible, elastic or resilient material so that the shape may change as indicated in FIG. 1B and the force acting on the first layer 110 may also act on the liquid or gas in the cavity 130.

However, the same effect may be achieved with a very stiff and rigid first layer 110 when other parts of the cavity 130 are flexible, elastic or resilient, such as for example the side walls 102 and/or 104. That is, the cavity 130, which forms a chamber for retaining the fluid, is adapted to change its volume once a force is applied from the outside.

Furthermore, the cavity 130 formed by the two layers and side walls is preferably sealed so that none of the fluid may escape or be pressed to the outside which may make calibration of the pressure sensing device 140 difficult. In other words, a closed compartment to store fluid is provided. As fluid, a gas or liquid or both may be used as long as a change in the shape or volume of the cavity 130 leads to an increase or decrease of the pressure in the fluid or fluids.

In the embodiment explained with respect to FIG. 1A, the pressure sensing device 140 for sensing this pressure increase or decrease is arranged on the circumference, in particular at the side wall 104. Similarly, the pressure sensing device 140 may also be arranged inside the cavity 130 as shown in FIG. 1B.

For example, the pressure sensing device 140 comprises a piezoresistive element so that an increase in pressure changes the resistivity of the piezoresistive element, which can be measured by measuring the change in resistivity of the element by measuring a change in voltage across the element. It is noted that silicon itself has piezoresistive properties and may be used as piezoresistive element, for example, incorporated in a micro-electromechanical structure (MEMS).

In one example, the second layer 120 may be made at least partially from silicon so that a silicon MEMS may be integrated therein. Typically a MEMS pressure sensor for absolute pressure measurements includes a vacuum chamber, wherein there is vacuum on one side and pressure on the other side of a membrane, e.g. a silicon structure, such as a bridge structure. A resistance change in the bridge structure can be measured by a voltage change over the bridge. These pressure sensors can also provide for temperature compensation. Alternatively also some special types of plastics or other membrane systems may be used as pressure sensing device 140.

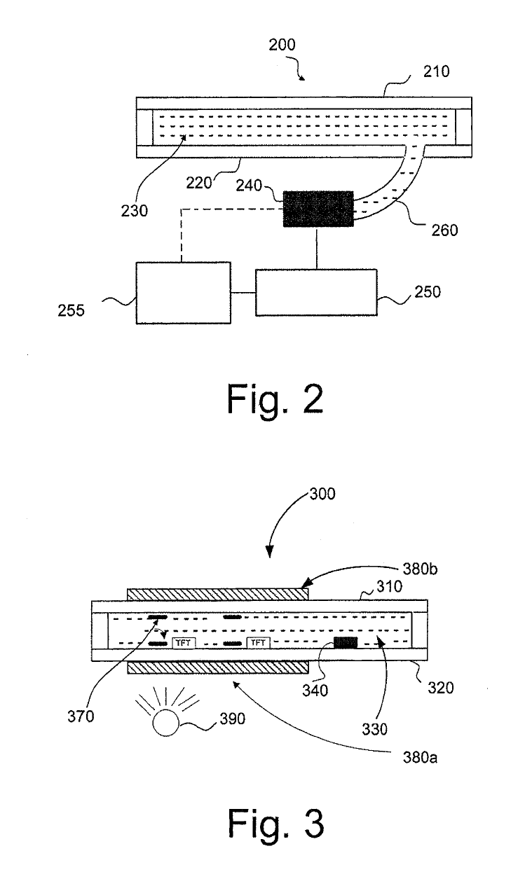

In the following, another display device will be explained with respect to FIG. 2. The display device 200 in FIG. 2 comprises a first layer 210, a second layer 220 forming a cavity 230 and a pressure sensing device 240.

These elements are basically the same as the elements described above with respect to FIGS. 1A and 1B. However, in display device 200 of FIG. 2 the pressure sensing device 240 is placed outside the cavity 230. In detail, in the embodiment described with respect to FIG. 2, the pressure sensing device 240 is coupled to the cavity 230 by a channel 260 adapted to carry the fluid. For example, the channel 260 may simply be etched in the material of the second layer, e.g. silicon, and optionally may be etched in further layers below or may be made of a tube, such as a plastic or rubber tube. This enables a high flexibility in positioning the pressure sensing device 240.

Additionally, the display device 200 comprises a determination section 250 and a controller 255 shown in FIG. 2, which are connected to the pressure sensing device 240. The determination section 250 and the controller 255 can similarly be used in conjunction with the display device 100, described above with respect to FIGS. 1A and 1B.

In detail, the determination section 250 determines a signal level based on the sensed pressure of the pressure sensing device 240. As described above, the sensed pressure depends on a force applied to the cavity 230, e.g. the first layer 210. For example, the pressure sensing device 240 outputs a voltage signal the height of which corresponds to the pressure so that an increase in pressure relates to an increase in voltage. Therefore, the signal level may simply correspond to the level of the voltage signal output by the pressure sensing device.

The determination section 250 may then determine from the signal level the force applied through a user input or the air pressure of the ambient pressure outside of the display device 200 pressing against the cavity.

Using calibration of the pressure sensing device 240, the display device 200 may thus provide a value of the force expressed in Newton or a value of the force expressed in a percentage change compared to a reference value.

The output of the pressure sensing device 240 may be directly input in a controller 255 or the controller 255 may receive the signal level determined by the determination section 250. Alternatively, the determination section 250 and the controller 255 may be integrated in one controller device.

As discussed above, the force applied on the display device is determined by the determination section 250. For example, a threshold value may be set in the determination section 250 to judge whether a user applied a force to the display device. In one example, the threshold value may be a voltage value that is compared to the voltage output of the pressure sensing device and if the output voltage exceeds the threshold value a trigger signal is sent to the controller 255 and a function of the display device can be triggered, e.g. an image on the display of the display device may be changed. Therefore, the display device 200 is adapted to serve as a user interface.

However, a force applied to the cavity does not necessarily have to be originated by the touch of a user, but the display device 200 may be operational to determine a change in the air pressure around the display device. This may be useful in weather applications that are presented on the display of the display device or to determine the altitude based on the air pressure/barometric pressure for sports, map or navigation applications.

This type of force or pressure sensing may be applied in any display device having a cavity including a fluid that changes the pressure when the volume of the cavity is changed. In the following, this will be described in more detail with respect to an LCD device but it is noted that the principle applies also to display devices having organic light emitting diodes and a pressure sensitive cavity as well as similar devices. Note that pressure variations due to temperature are negligible for normal ambient temperatures but may also be calibrated using a temperature sensor if necessary.

In the following, a specific display device will be explained with respect to FIG. 3. In FIG. 3 the display device 300 constitutes an LCD device.

The display device 300 comprises a first layer 310, a second layer 320 forming a cavity 330 and a pressure sensing device 340. These elements are similar and provide largely the same functions as the previously described first layers 110 and 210, second layers 120 and 220, cavities 130 and 230 and pressure sensing devices 140 and 240 and thus it is referred to the discussion above for details.

Additionally, the display device 300 comprises two electrodes 370 arranged between the first layer 310 and the second layer 320, two polarizers 380 and a light source 390. In this example, the fluid is a birefringent liquid, e.g. a liquid crystal that enables rotation of the polarization direction of light. Birefringent materials can be described by assigning two different refractive indices to the material for different polarization axes, namely an ordinary direction and an extraordinary direction defined by the molecule.

By applying a voltage to one of the electrodes to generate a potential difference between the electrodes, the molecules, such as liquid crystal molecules, in the birefringent liquid may be aligned in a particular direction so as to change the polarization property of the birefringent liquid from a random state to a directed state. Linearly polarized light entering the cavity 330 with the aligned liquid crystals travels through the liquid and as a result of the anisotropy of the birefringent liquid, the polarization of the light is rotated.

By providing two polarizers with their polarization directions being perpendicular to each other, such as polarizers 380 in FIG. 3, a light switch is formed. If the liquid crystal molecules are randomly distributed, light from a light source 390 and polarized by the lower polarizer 380a propagates with its polarization direction unchanged through the cavity 330 and cannot pass the upper polarizer 380b, since its polarization direction is perpendicular to the one of the lower polarizer 380a. However, once a potential difference is provided by the electrodes 370, which are preferably made of a transparent conductor, such as indium tin oxide (ITO), the liquid crystal molecules are aligned and the polarization direction of the incident light is rotated, e.g. by 90°, so as to pass the upper polarizer 380b.

The electrodes 370 may be switched on and off by thin-film transistors (TFTs), one provided for each lower electrode. Therefore, depending on the alignment of liquid crystal molecules in the cavity 330, light from the light source 390 passes or is blocked by the display device 300 so as to provide an image on the upper side of display device 300.

In an LCD device, typically thousands of electrodes are provided for switching on/off the pixels, wherein the birefringent liquid is distributed between the electrodes in the cavity 330 which is sealed on the sides. Due to the largely non-directional pressure change in the cavity 330, when a force is applied to the top, the pressure sensing device 340 may be arranged almost anywhere in the cavity as long as it does not interfere with the light paths of the pixels and as long as it is in contact with the liquid either directly in the cavity or through a channel.

In an active display device having a light source, such as the one shown in FIG. 3, the second layer 320 is made at least partly of a transparent material so that light from the light source 390 may enter the cavity 330. Similar to the first layer, several materials may be used, such as different kinds of glass or transparent plastics.

In FIG. 3, a display device of a transmissive type with an active artificial light source 390 is provided. However, a display device can also be of a reflective type without an artificial light source. Such a passive display device uses light incident from the surrounding which is then partly reflected at the second layer 320 and re-emitted by the display device if an upper polarizer, such as polarizer 380, allows the light to be re-emitted.

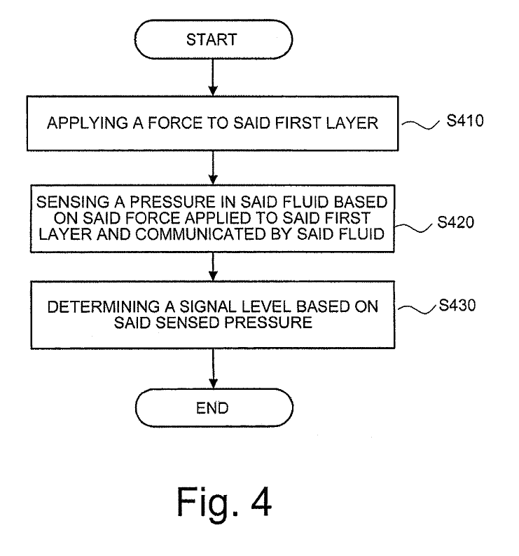

In the following, operations of a method for sensing a force on a display device, such as the display device 100, 200 or 300, will be described with respect to FIG. 4.

In the first step S410 a force is applied to a first layer of the display device, which may be a top layer or may be an intermediate layer on which other layers including a top layer defining a touch surface are provided.

In step S420, a pressure in the fluid is sensed. As described above, the pressure in the fluid may increase due to a force applied to the first layer of a cavity, wherein the fluid serves to communicate the effect of the force, i.e. the pressure increase.

In a further step S430, a signal level is determined based on the sensed pressure. For example, the pressure is sensed by a pressure sensing device, as explained above, which outputs a voltage signal and based on the voltage signal or the voltage signal change the presence of the force may be detected, which may be defined as an input operation of a user. For example, a threshold of a voltage value may be defined, which lies in between a voltage output at ambient pressure and a voltage output when a force is applied. Therefore, once the determination section or controller detects a voltage value larger than the threshold value, it is determined that a user presses a finger, a hand or a stylus on the display device performing an input operation.

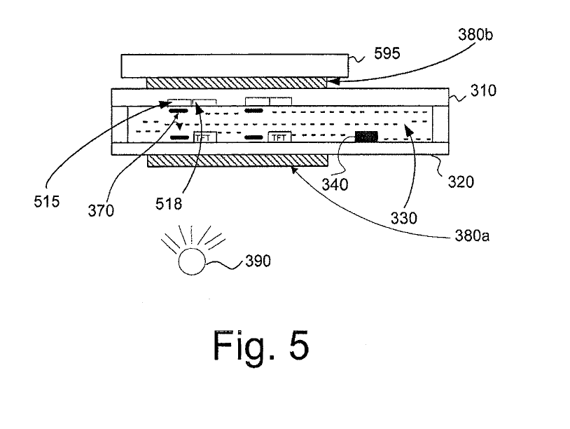

Next, a touch screen device is explained with respect to FIG. 5.

FIG. 5 illustrates a touch screen device 500 comprising the display device 300 of FIG. 3. Additionally, the display device 500 also comprises a touch sensor 595, color filters 515 and black matrix parts 518 shown in layer 310. The color filters 515 and leg matrix parts 518 define the size and color of the visible pixel. The touch sensor 595 is arranged on one side of the first layer 310 other than the side facing the fluid to sense a position touched on a touch area, such as an x,y-coordinate plane, defined by the touch sensor.

The touch sensor 595 may be a conventional touch sensor of a capacitive or resistive type, as explained above, e.g. having capacitive components in a first and a second layer to provide a matrix structure enabling to obtain the x,y-coordinates of the location where a user touches the touch area. Since several different kinds of conventional touch sensors are well known to the skilled person, a more detailed description will be omitted.

Therefore, in addition to one or more input parameters in the z-direction due to the pressure increase, also an x,y-position may be obtained as an input parameter to the touch screen device 500. Consequently, the touch screen device 500 is adapted to be a force-sensitive touch screen device to trigger different functions depending on the position touched and the magnitude of the force exerted by the touch.

For example, a user may select an object on the display at a specific x,y-coordinate by pressing on the touch area corresponding to this coordinate with a force F₁ to select the object and by pressing stronger with a force F₂ the object may be cut or copied. Furthermore, the user may press another x,y-coordinate with the force F₁ and may paste the object to this position by pressing with the force F₂.

Several other drag and drop or copy and paste applications can be implemented with a simple configuration using x,y,z-input parameters. Therefore, in addition to the input operations of a known touch sensor one additional input dimension is added, which can be used to trigger several different functions depending on several different forces applied to the display device.

Further, the touch sensor 595 may also be helpful for calibration. As was explained in FIG. 1B, the side walls 102 and 104 of the display device 100 were assumed to be relatively stiff so that the sensitivity of the display device 100 may vary depending on where the force is applied, namely on the middle or on the left or right side of the first layer. This difference is, however, predictable in several ways and compensation for this difference in sensitivity can be thought of.

For example, when knowing x,y-coordinates of where on the first layer the force is applied, e.g. by using the touch sensor 595, a look-up table or an arithmetic calculation may be used where the x,y-coordinates are used as input parameters.

Further, only relative measurements of the forces or pressures are required in many applications, namely a user may press with a certain force to indicate a single click and with double the force to indicate a double click, so that calibration is not necessarily needed and changes in sensitivity depending on different stiffnesses where the force is applied can be handled successfully.

In one embodiment, the touch screen device 500 comprises the controller 255. The controller 255 may be adapted to supply a current to the pressure sensing device 240 only when the touch sensor 595 senses a touch. For example, if a touch is sensed by the touch sensor 595, the current is supplied so that also the force of the touch in z-direction can be estimated. In other words, the pressure sensing device 240 is only activated as long as there is a finger, a hand, a stylus or other object present on the touch area. Therefore, power may be saved, since the pressure sensing device 240 is only energised when the display device is touched.

In another embodiment, the display device 100, 200 or 300 or the touch screen device 500 is incorporated in a mobile device, such as a cellular phone or other type of mobile phone, or a portable computer. The applications of the display device or touch screen device are clearly not limited to mobile devices but incorporation in mobile devices is particularly advantageous, since these devices are usually small and require intelligent user interfaces to trigger various functions. Therefore, incorporating the display device or touch screen device in a mobile device is advantageous.

The description above has been explained with respect to several individual elements, such as the controller 255, the determination section 250, the pressure sensing device 260, etc., and it should be understood that the invention is not limited in a way that these elements are structural independent units but these elements should be understood as elements comprising different functions. In other words, it is understood by the skilled person that an element in the above-described embodiments is not construed as being limited to a separate tangible part but is understood as a kind of functional entity so that several functions may also be provided in one tangible part. For example, the function of the determination section may be incorporated into the controller.

Moreover, the physical entities according to the invention and/or its embodiments may comprise or store computer programmes including instructions such that, when the computer programmes are executed on the physical entities, steps, procedures and functions of these elements are carried out according to embodiments of the invention. The invention also relates to computer programmes for carrying out the function of the elements, and to a computer-readable medium storing the computer programmes for carrying out methods according to the invention.

The above described elements of the display devices 100, 200 and 300 as well as of the touch screen device 500 may be implemented in hardware, software, field-programmable gate arrays (FPGAs), applications specific integrated circuits (ASICs), firmware or the like.

It will be appreciated that various modifications and variations can be made in the described elements, display devices, touch screen devices, mobile devices and methods as well as in the construction of this invention without departing from the scope or spirit of the invention. The invention has been described in relation to particular embodiments which are intended in all aspects to be illustrative rather than restrictive. Those skilled in the art will appreciate that many different combinations of hardware, software and firmware are suitable for practising the invention.

Moreover, other implementations of the invention will be apparent to the skilled person from consideration of the specification and practice of the invention disclosed herein. It is intended that the specification and the examples are considered as exemplary only. To this end, it is to be understood that inventive aspects may lie in less than all features of a single foregoing disclosed implementation or configuration. Thus, the true scope and spirit of the invention is indicated by the following claims.

1. A display device, comprising
a first layer made at least partly of a transparent material;
a second layer arranged at one side of the first layer, the first and second layers forming faces of a cavity including a fluid; and
a pressure sensing device for sensing a pressure in said fluid.

2. The display device of claim 1, wherein said pressure sensing device and said cavity are adapted and coupled so that a force applied to said first layer of said cavity is communicable by said fluid to said pressure sensing device.

3. The display device of claim 1, wherein said pressure sensing device is arranged inside said cavity or on the circumference of said cavity.

4. The display device of claim 1, wherein said pressure sensing device is placed outside said cavity and said cavity is coupled with said pressure sensing device by a channel adapted to carry said fluid.

5. The display device of claim 1, wherein said pressure sensing device comprises a piezoresistive element.

6. The display device of claim 1, wherein said fluid is a birefringent liquid.

7. The display device of claim 6, further comprising two electrodes arranged between said first and second layers so as to change the polarization property of said birefringent liquid.

8. The display device of claim 6, further comprising two polarizers with their polarization directions being perpendicular to each other.

9. The display device of claim 1, further comprising
a determination section for determining a signal level based on the sensed pressure.

10. The display device of claim 9, wherein the determination section is adapted to determine at least one of a force applied through a user input and the air pressure.

11. Touch screen device comprising said display device of claim 1.

12. The touch screen device of claim 11, wherein said second layer is made at least partly of a transparent material and a light source is provided on a side of said second layer other than the side facing said fluid.

13. The touch screen device of claim 11, further comprising
a touch sensor arranged on a side of said first layer other than the side facing said fluid to sense a position touched on a touch area defined by said touch sensor.

14. Mobile device comprising said display device of claim 1.

15. Method for sensing a force on a display device having a first layer and a second layer forming faces of a cavity including a fluid, comprising the steps
applying a force to said first layer;
sensing a pressure in said fluid based on said force applied to said first layer and communicated by said fluid; and
determining a signal level based on said sensed pressure.

16. Mobile device comprising said touch screen of claim 11.
